(19) United States
(12) Patent Application Publication
(10) Pub. No.: US 2008/0111938 A1
(43) Pub. Date: May 15, 2008

(54) SUPPORTING UNIT FOR LIQUID CRYSTAL DISPLAY APPARATUS, BACKLIGHT ASSEMBLY AND LIQUID CRYSTAL DISPLAY APPARATUS HAVING THE SAME

(75) Inventors: Jong-Dae PARK, Seoul (KR); Seok-Won LEE, Yongin-si (KR); Tae-Jin LEE, Gyeonggi-do (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 11/972,735

(22) Filed: Jan. 11, 2008

Related U.S. Application Data
(62) Division of application No. 10/850,602, filed on May 20, 2004.

(30) Foreign Application Priority Data
Dec. 31, 2002 (KR) 2002-87956

(51) Int. Cl. G02F 1/1333; G09G 3/36

(52) U.S. Cl. 349/58; 248/917

(57) ABSTRACT

A supporting unit includes a first support frame, a second support frame and an impurity barrier. The first support frame supports an LCD panel, and includes an opening through which a light is supplied to the LCD panel. The second support frame is protruded from sides of the first support frame to surround sides of the LCD panel. The impurity barrier is disposed on a surface of the first support frame corresponding to the liquid crystal display panel to prevent an inflow of impurities into a space between the first support frame and the liquid crystal display panel. Therefore, the supporting unit for the LCD panel includes the impurity barrier to prevent the inflow of the impurities that is externally provided into the space between the supporting unit and the LCD panel, thereby improving image display quality.

### BACKGROUND OF THE INVENTION

1. Field of the Invention

The present invention relates to a supporting unit for a liquid crystal display (LCD) panel, a backlight assembly having the supporting unit and an LCD apparatus having the supporting unit. More particularly, the present invention relates to a supporting unit for an LCD panel, which is capable of preventing pollution of a display region, a backlight assembly having the supporting unit and an LCD apparatus having the supporting unit.

2. Description of the Related Art

A liquid crystal display (LCD) apparatus displays an image using a liquid crystal.

The LCD apparatus includes a light generating unit and a liquid crystal controlling unit. A receiving container receives the light generating unit and the liquid crystal controlling unit.

Impurities disposed between the light generating unit and the liquid crystal controlling unit block a light to deteriorate display quality of an image.

In order to prevent the pollution of the LCD apparatus, the light generating unit and the liquid crystal controlling unit are manufactured and received in the receiving container in a clean room.

The LCD apparatus, however, is operated in an atmosphere that is exposed by the impurities such as dusts, particles, liquid pollutants, etc., so that the LCD apparatus may be polluted, thereby deteriorating image display quality.

### BRIEF SUMMARY OF THE INVENTION

The present invention provides a supporting unit for an LCD panel, which is capable of preventing pollution of a display region, a backlight assembly having the supporting unit and an LCD apparatus having the supporting unit.

The present invention also provides a backlight assembly having the supporting unit.

The present invention also provides an LCD apparatus having the supporting unit.

The supporting unit in accordance with an exemplary embodiment of the present invention includes a first support frame, a second support frame and an impurity barrier. The first support frame supports a liquid crystal display panel, and includes an opening through which a light is supplied to the liquid crystal display panel. The second support frame is protruded from sides of the first support frame to surround sides of the liquid crystal display panel. The impurity barrier is disposed on a surface of the first support frame corresponding to the liquid crystal display panel to prevent an inflow of impurities into a space between the first support frame and the liquid crystal display panel.

The backlight assembly in accordance with an exemplary embodiment of the present invention includes a first receiving container, a lamp unit, a supporting unit and a second receiving container.

The first receiving container includes a first bottom surface and a plurality of first sidewalls disposed on sides of the first bottom surface to form a receiving space. The lamp unit is disposed in the receiving space to generate a light. The supporting unit includes a first support frame, a second support frame and an impurity barrier. The first support frame has an opening through which the light is supplied to a liquid crystal display panel, and supports the liquid crystal display panel. The second support frame is protruded from sides of the first support frame to surround sides of the liquid crystal display panel. The impurity barrier is disposed on a surface of the first support frame corresponding to the liquid crystal display panel to prevent an inflow of impurities into a space between the first support frame and the liquid crystal display panel. The second receiving container includes a second bottom surface and a plurality of second sidewalls disposed on sides of the second bottom surface to surround the first sidewalls of the first receiving container.

The liquid crystal display apparatus in accordance with an exemplary embodiment of the present invention includes a first receiving container, a lamp unit, a liquid crystal display panel, a supporting unit, a second receiving container and a chassis. The first receiving container includes a first bottom surface and a plurality of first sidewalls disposed on sides of the first bottom surface to form a receiving space. The lamp unit is disposed in the receiving space to generate a light. The liquid crystal display panel transforms the light into an image light. The supporting unit includes a first support frame, a second support frame and an impurity barrier. The first support frame has an opening through which the light is supplied to the liquid crystal display panel, and supports the liquid crystal display panel. The second support frame is protruded from sides of the first support frame to surround sides of the liquid crystal display panel. The impurity barrier is disposed on a surface of the first support frame corresponding to the liquid crystal display panel to prevent an inflow of impurities into a space between the first support frame and the liquid crystal display panel. The second receiving container includes a second bottom surface and a plurality of second sidewalls disposed on sides of the second bottom surface to surround the first sidewalls of the first receiving container. The chassis includes a top chassis wall and a plurality of side chassis walls that surrounds the liquid crystal display panel. A central portion of the top chassis wall is opened to expose a central portion of the liquid crystal display panel.

The impurities may include dusts, particles, liquid pollutants, etc.

Therefore, the supporting unit for the LCD panel includes the impurity barrier to prevent the inflow of the impurities that is externally provided into the space between the supporting unit and the LCD panel, thereby improving image display quality.

### BRIEF DESCRIPTION OF THE DRAWINGS

The above and other advantages of the present invention will become more apparent by describing in detail exemplary embodiments thereof with reference to the accompanying drawings, in which:

FIG. 1 is a perspective view showing a supporting unit for an LCD panel according to an exemplary embodiment;

FIG. 2 is a cross-sectional view taken along a line A-A′ shown in FIG. 1;

FIG. 3 is a partially cut out perspective view showing a supporting unit for an LCD panel according to another exemplary embodiment;

FIG. 4 is an enlarged view showing a portion ‘B’ shown in FIG. 3;

FIG. 5 is a partially cut out perspective view showing a supporting unit for an LCD panel according to another exemplary embodiment;

FIG. 6 is an enlarged view showing a portion ‘C’ shown in FIG. 5;

FIG. 7 is a partially cut out perspective view showing a supporting unit for an LCD panel according to another exemplary embodiment;

FIG. 8 is an enlarged view showing a portion ‘D’ shown in FIG. 7;

FIG. 9 is a perspective view showing a supporting unit for an LCD panel according to another exemplary embodiment;

FIG. 10 is an enlarged view showing a portion ‘E’ shown in FIG. 9;

FIG. 11 is a partially cut out perspective view showing a supporting unit for an LCD panel according to another exemplary embodiment;

FIG. 12 is an enlarged view showing a portion ‘F’ shown in FIG. 11;

FIG. 13 is a partially cut out perspective view showing a supporting unit for an LCD panel according to another exemplary embodiment;

FIG. 14 is an enlarged view showing a portion ‘G’ shown in FIG. 13;

FIG. 15 is a partially cut out perspective view showing a supporting unit for an LCD panel according to another exemplary embodiment;

FIG. 16 is an enlarged view showing a portion ‘H’ shown in FIG. 15;

FIG. 17 is a partially cut out perspective view showing a supporting unit for an LCD panel according to another exemplary embodiment;

FIG. 18 is an enlarged view showing a portion ‘I’ shown in FIG. 17;

FIG. 19 is a partially cut out perspective view showing a supporting unit for an LCD panel according to another exemplary embodiment;

FIG. 20 is an enlarged view showing a portion ‘J’ shown in FIG. 19;

FIG. 21 is an enlarged partially cut out perspective view showing a supporting unit for an LCD panel according to another exemplary embodiment;

FIG. 22 is an enlarged partially cut out perspective view showing a supporting unit for an LCD panel according to another exemplary embodiment;

FIG. 23 is a partially cut out perspective view showing a supporting unit for an LCD panel according to another exemplary embodiment;

FIG. 24 is an enlarged view showing a portion ‘K’ shown in FIG. 23;

FIG. 25 is an exploded perspective view showing a backlight assembly according to an exemplary embodiment; and

FIG. 26 is an exploded perspective view showing an LCD apparatus according to an exemplary embodiment.

### DESCRIPTION OF THE PREFERRED EMBODIMENTS

Hereinafter, the present invention will be described in detail with reference to the accompanying drawings.

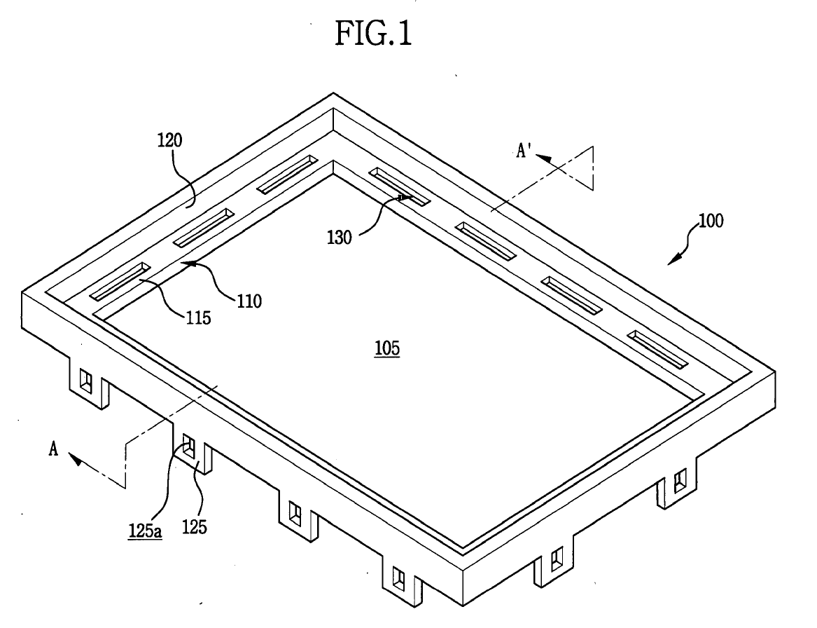

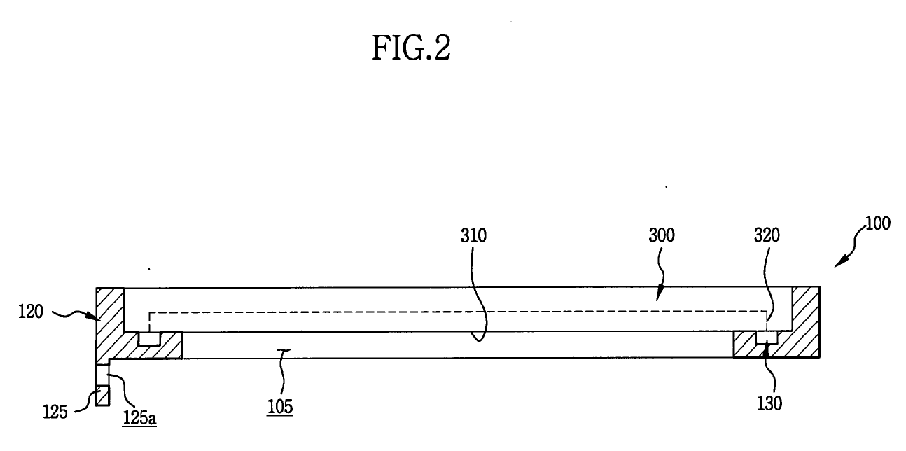

FIG. 1 is a perspective view showing a supporting unit for an LCD panel according to an exemplary embodiment. FIG. 2 is a cross-sectional view taken along a line A-A′ shown in FIG. 1.

Referring to FIGS. 1 and 2, the supporting unit 100 for the liquid crystal display (LCD) panel 300 supports the LCD panel 300. The supporting unit 100 has a rectangular shape including an opening 105 formed on a central portion of the supporting unit 100.

The supporting unit 100 includes a first support frame 110, a second support frame 120 and an impurity barrier 130.

The first support frame 110 supports a bottom surface 310 of the LCD panel 300. A first surface 115 of the first support frame 110 makes contact with sides of the bottom surface 310 of the LCD panel 300. The bottom surface 310 of the LCD panel 300 has a rectangular shape, and the first support frame 110 also has a rectangular shape.

The second support frame 120 is extended along sidewalls 320 of the LCD panel 300 to surround the LCD panel 300. The first and second support frames 110 and 120 may be formed by an injection molding method, or the second support frame 120 may also be attached to the first support frame 110 to form the supporting unit 100.

The second support frame 120 includes a securing portion 125 that is protruded outside the second support frame 120. The securing portion 125 includes a securing hole 125a.

The impurity barrier 130 prevents an inflow of the impurities into a space between the first support frame 110 and the bottom surface 310 of the LCD panel 300.

The impurity barrier 130 is formed at the first surface 115 of the first support frame 110. The first surface 115 faces the bottom surface 310 of the LCD panel 300. The impurity barrier 130 includes a recess formed at the first surface 115. The impurity barrier 130 may include a plurality of the recesses.

The impurities, which are externally provided to the space between the bottom surface 310 of the LCD panel 300 and the first supporting frame 110, are captured in the impurity barrier 130 by a gravitational force to prevent the inflow of the impurities into the space.

According to the exemplary embodiment, the impurity barrier 130 of the first support frame 110 includes the recess formed at the first surface 115 to capture the impurities, thereby improving display quality.

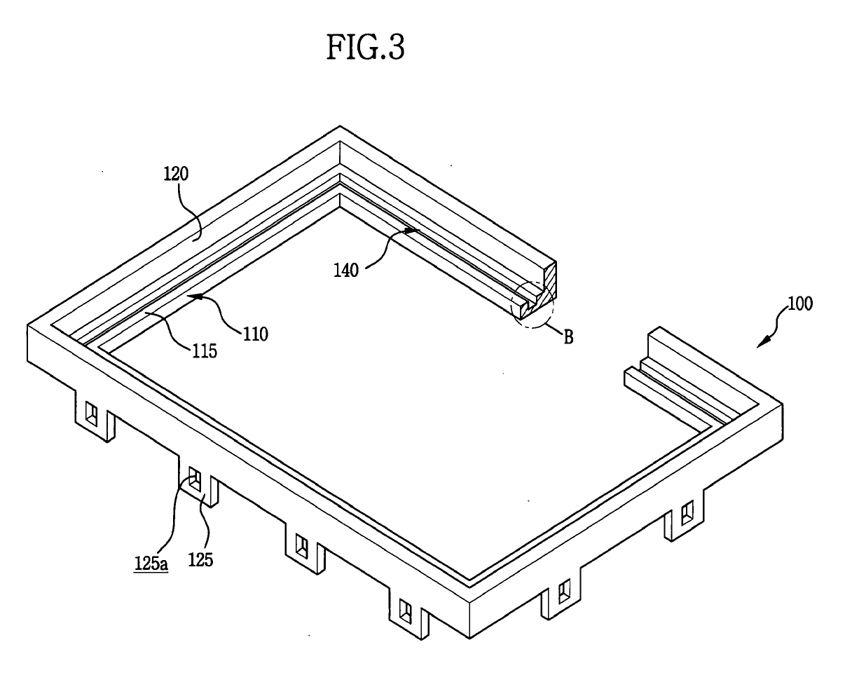

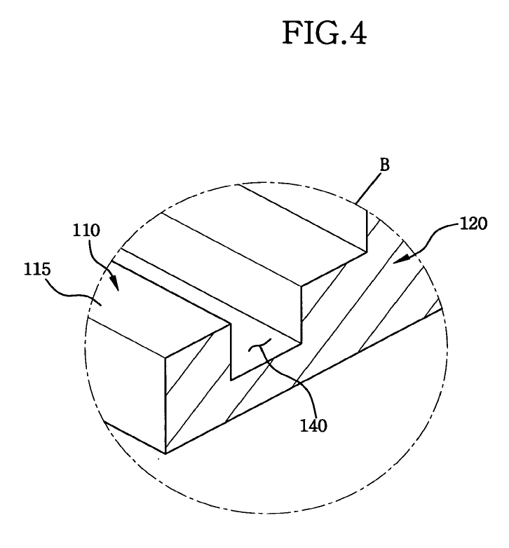

FIG. 3 is a partially cut out perspective view showing a supporting unit for an LCD panel according to another exemplary embodiment. FIG. 4 is an enlarged view showing a portion ‘B’ shown in FIG. 3.

The supporting unit for the LCD panel of FIGS. 3 and 4 is same as in FIGS. 1 and 2 except an impurity barrier. Thus, the same reference numerals will be used to refer to the same or like parts as those described in FIGS. 1 and 2 and any further explanation will be omitted.

Referring to FIGS. 3 and 4, the impurity barrier 140 includes a groove formed along a first surface 115 of a first support frame 110. The impurity barrier 140 includes a first depth. Preferably, the impurity barrier 140 has a closed loop shape that surrounds an opening 105 that is formed on a central portion of the supporting unit 100.

According to the exemplary embodiment, the impurity barrier 140 includes the groove to capture the impurities by a gravitational force. The impurity barrier 140 may include a plurality of the grooves.

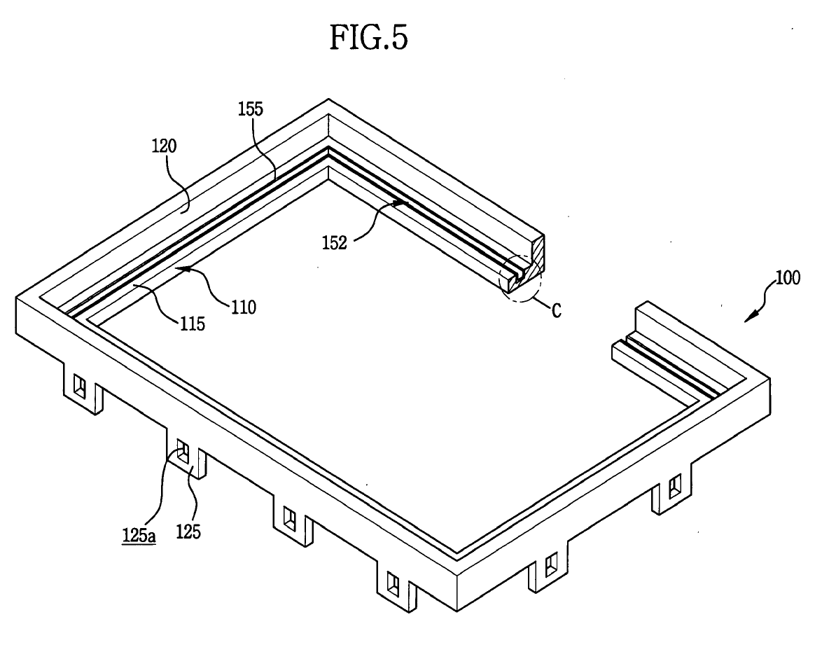

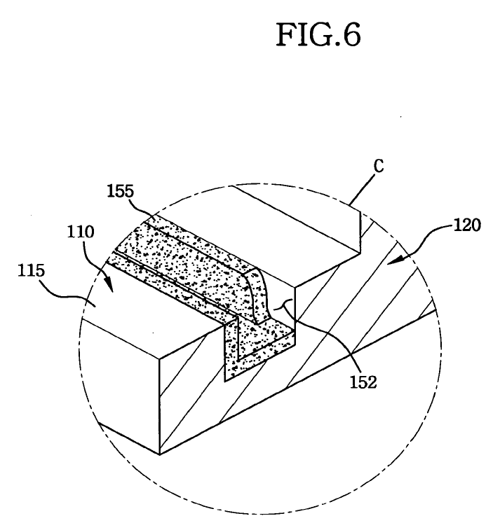

FIG. 5 is a partially cut out perspective view showing a supporting unit for an LCD panel according to another exemplary embodiment. FIG. 6 is an enlarged view showing a portion ‘C’ shown in FIG. 5.

The supporting unit for the LCD panel in FIGS. 5 and 6 is same as in FIGS. 1 and 2 except an impurity barrier. Thus, the same reference numerals will be used to refer to the same or like parts as those described in FIGS. 1 and 2 and any further explanation will be omitted.

Referring to FIGS. 5 and 6, an impurity barrier 150 is formed on a first surface 115 of a first support frame 110. The impurity barrier 150 includes a groove 152 formed along a first surface 115 of a first support frame 110 and a double-sided tape 155 disposed in the groove 152.

Impurities, which are externally provided to a space between a bottom surface of the LCD panel and the first supporting frame 110, are captured in the impurity barrier 150 by a gravitational force. The double-sided tape 155 is disposed in the groove 152 to attach the captured impurities on an exposed surface of the double-sided tape 155. Therefore, the attached impurities may not be separated from the impurity barrier 150 although an LCD apparatus is impacted by an external force.

According to the present invention, the impurity barrier 150 includes the groove 152 and the double-sided tape 155 to prevent the separation of the impurities from the impurity barrier 150.

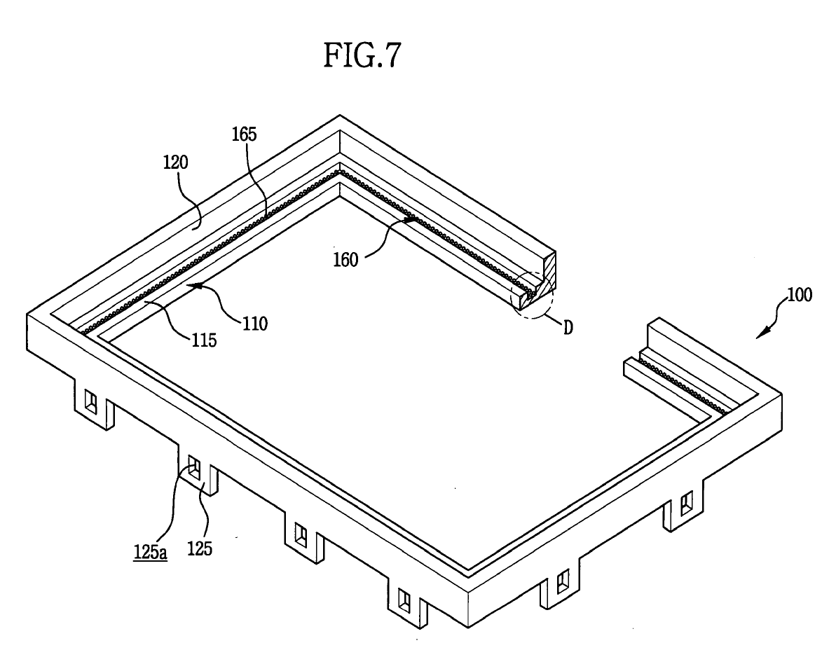

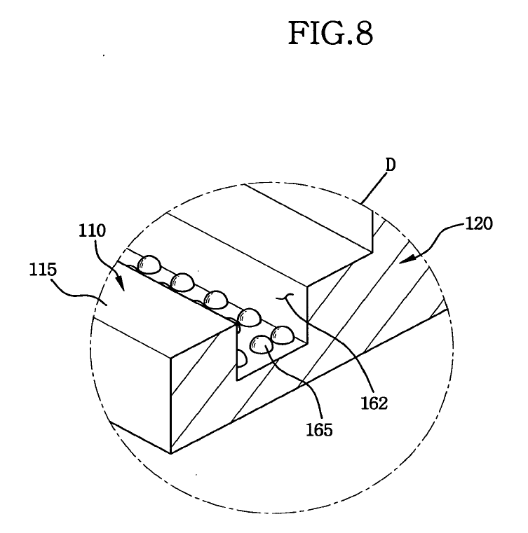

FIG. 7 is a partially cut out perspective view showing a supporting unit for an LCD panel according to another exemplary embodiment. FIG. 8 is an enlarged view showing a portion ‘D’ shown in FIG. 7.

The supporting unit for the LCD panel in FIGS. 7 and 8 is same as in FIGS. 1 and 2 except an impurity barrier. Thus, the same reference numerals will be used to refer to the same or like parts as those described in FIGS. 1 and 2 and any further explanation will be omitted.

Referring to FIGS. 7 and 8, an impurity barrier 160 is formed on a first surface 115 of a first support frame 110. The impurity barrier 160 includes a groove 162 and a plurality of protrusions 165 disposed in the groove 162.

Impurities, which are externally provided to a space between a bottom surface of the LCD panel and the first supporting frame 110, are captured in the impurity barrier 160 by a gravitational force. The protrusions 165 are disposed in the groove 162 so that the captured impurities are disposed between the protrusions 165. Therefore, the captured impurities may not be separated easily from the impurity barrier 160 although an LCD apparatus is impacted by an external force.

The groove 162 and the protrusions 165 may be formed together with the first support frame 110 by an injection molding method.

According to the exemplary embodiment, the impurity barrier 160 includes the groove 162 and the protrusions 165 to simplify the manufacturing process of the supporting unit 100.

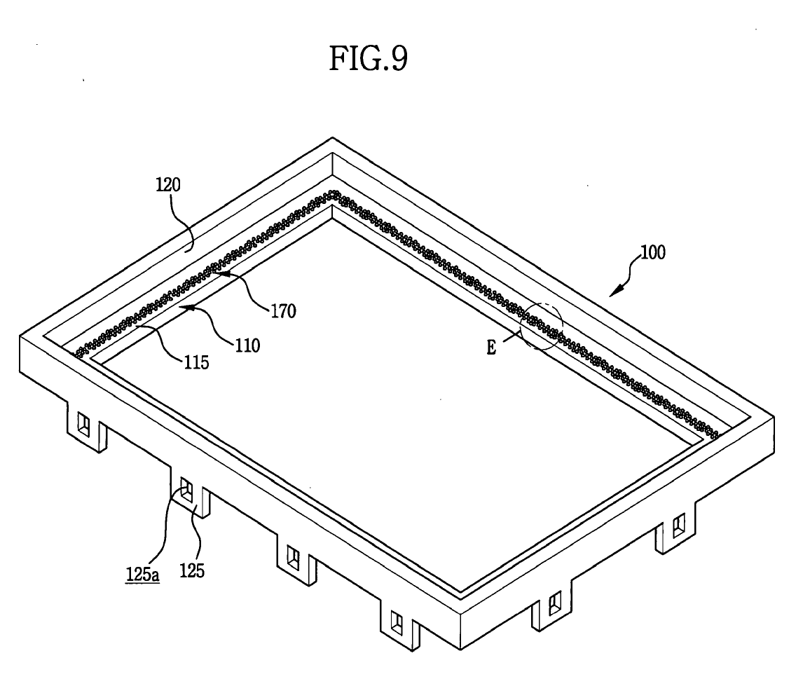

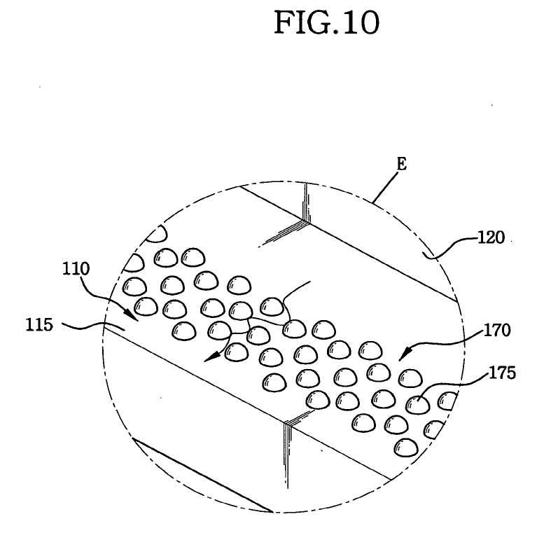

FIG. 9 is a perspective view showing a supporting unit for an LCD panel according to another exemplary embodiment. FIG. 10 is an enlarged view showing a portion ‘E’ shown in FIG. 9.

The supporting unit for the LCD panel in FIGS. 9 and 10 is same as in FIGS. 1 and 2 except an impurity barrier. Thus, the same reference numerals will be used to refer to the same or like parts as those described in FIGS. 1 and 2 and any further explanation will be omitted.

Referring to FIGS. 9 and 10, an impurity barrier 170 is formed on a first surface 115 of a first support frame 110. The impurity barrier 170 includes a plurality of protrusions 175 formed on the first surface 115 of the first support frame 110. The size of the protrusions 175 and the interval between the protrusions 175 are adjusted so as to increase a path length of impurities so that the impurities may not pass through the impurity barrier 170. Therefore, the impurity barrier 170 prevents an inflow of the impurities into a space between the first surface 115 of the first support frame 110 and the bottom surface of the LCD panel. Preferably, the protrusions 175 are arranged in a band shape having a closed loop that surrounds an opening of the supporting unit 100.

According to the exemplary embodiment, the protrusions 175 disposed on the first surface 115 are arranged in the band shape having the closed loop to prevent the inflow of the impurities into a space between the first support frame 110 and the bottom surface of the LCD panel.

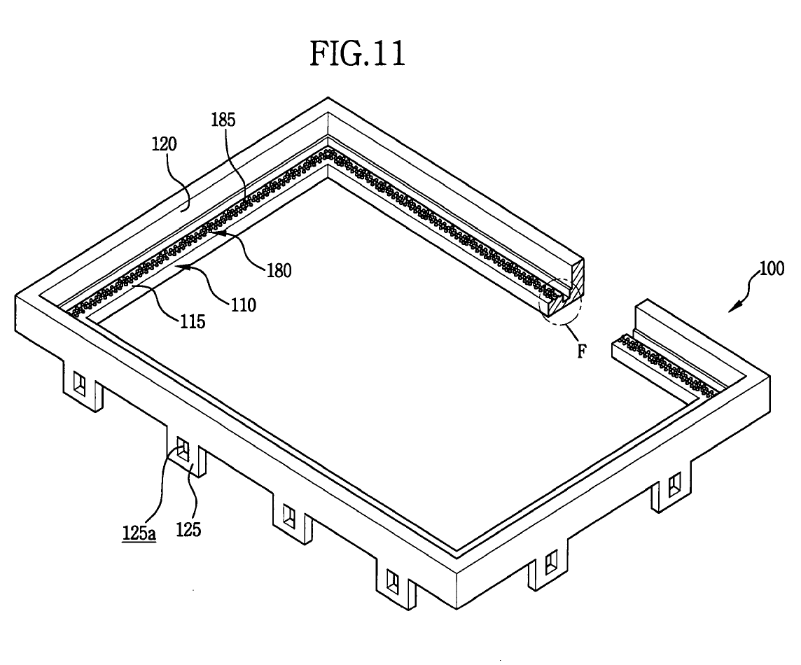

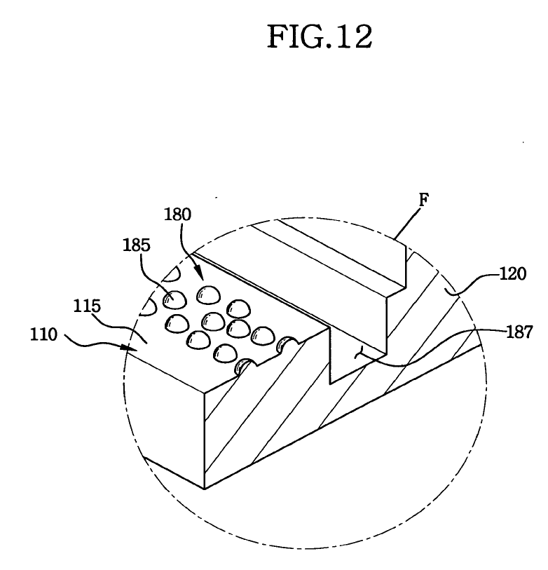

FIG. 11 is a partially cut out perspective view showing a supporting unit for an LCD panel according to another exemplary embodiment. FIG. 12 is an enlarged view showing a portion ‘F’ shown in FIG. 11.

The supporting unit for the LCD panel in FIGS. 11 and 12 is same as in FIGS. 1 and 2 except an impurity barrier. Thus, the same reference numerals will be used to refer to the same or like parts as those described in FIGS. 1 and 2 and any further explanation will be omitted.

Referring to FIGS. 11 and 12, an impurity barrier 180 is formed on a first surface 115 of a first support frame 110. The impurity barrier 180 includes a plurality of protrusions 185 disposed on the first surface 115 and a groove 187 formed at the first surface 115.

The groove 187 is formed between the protrusions 185 and a second support frame 120 so that a portion of impurities, which are externally provided to a space between a bottom surface of the LCD panel and the first support frame 110, are captured in the groove 187 by a gravitational force, thereby decreasing the amount of an inflow of the impurities into the space.

The protrusions 185 disposed on the first surface 115 are arranged in a band shape to increase a path length of impurities so that a remaining portion of the impurities may not pass through the impurity barrier 180. Therefore, the impurity barrier 180 prevents the inflow of the impurities into a space between the first surface 115 of the first support frame 110 and the bottom surface of the LCD panel.

According to the exemplary embodiment, the impurity barrier 180 includes the protrusions 195 and the groove 187 disposed between the protrusions 185 and the second support frame 120 so as to prevent the inflow of the impurities into the space.

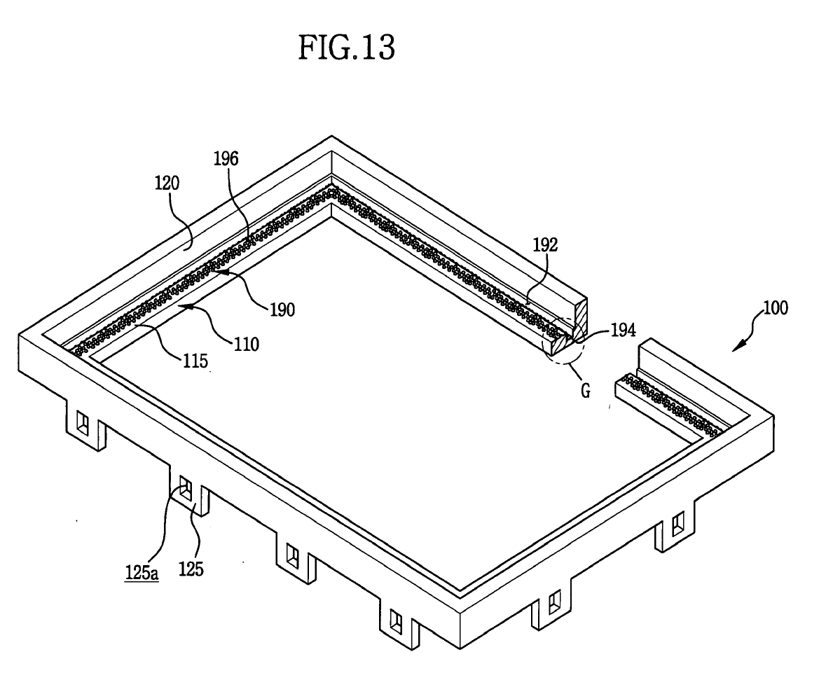

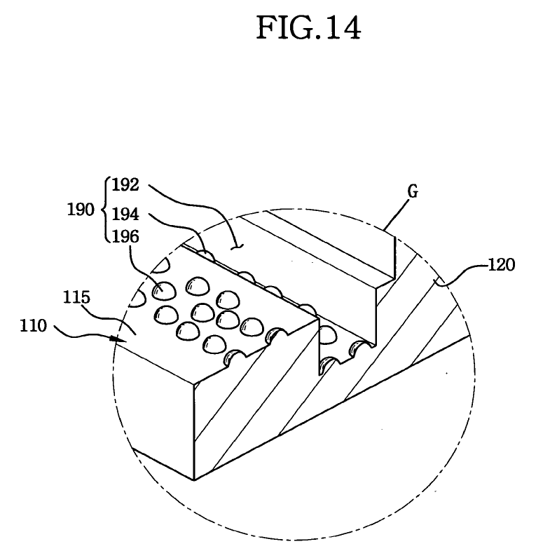

FIG. 13 is a partially cut out perspective view showing a supporting unit for an LCD panel according to another exemplary embodiment. FIG. 14 is an enlarged view showing a portion ‘G’ shown in FIG. 13.

The supporting unit for the LCD panel in FIGS. 13 and 14 is same as in FIGS. 1 and 2 except an impurity barrier. Thus, the same reference numerals will be used to refer to the same or like parts as those described in FIGS. 1 and 2 and any further explanation will be omitted.

Referring to FIGS. 13 and 14, an impurity barrier 190 is formed on a first surface 115 of a first support frame 110. The impurity barrier 190 includes a groove 192, a plurality of first protrusions 194 disposed in the groove 192 and a plurality of second protrusions 196 disposed on the first surface 115.

The groove 192 has a band shape. A portion of impurities, which are externally provided to a space between the bottom surface of the LCD panel and the first supporting frame 110, are captured in the impurity barrier 190 by a gravitational force. The first protrusions 194 are formed in the groove 192 so that the captured impurities are disposed between the first protrusions 194. Therefore, the captured impurities may not be separated from the groove 192 although an LCD apparatus is impacted by an external force.

The second protrusions 196 disposed on the first surface 115 of the first support frame 110 are arranged in a band shape to increase a path length of a remaining impurities, thereby preventing an inflow of the remaining impurities into the space.

According to the exemplary embodiment, the impurity barrier 190 includes the groove 192, the first protrusions 194 disposed in the groove 192 and the second protrusions 196 disposed on the first surface 115 so that the impurities may not pass through the impurity barrier 190.

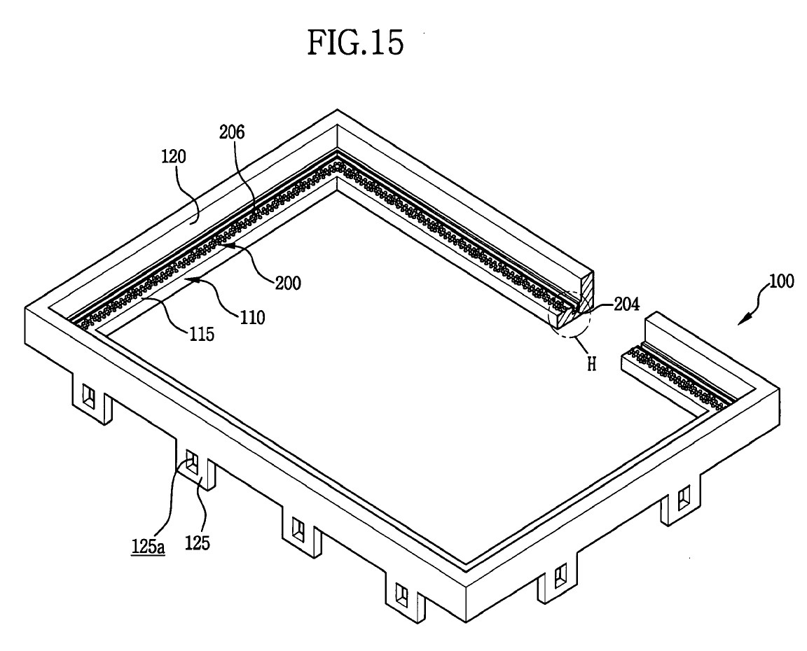

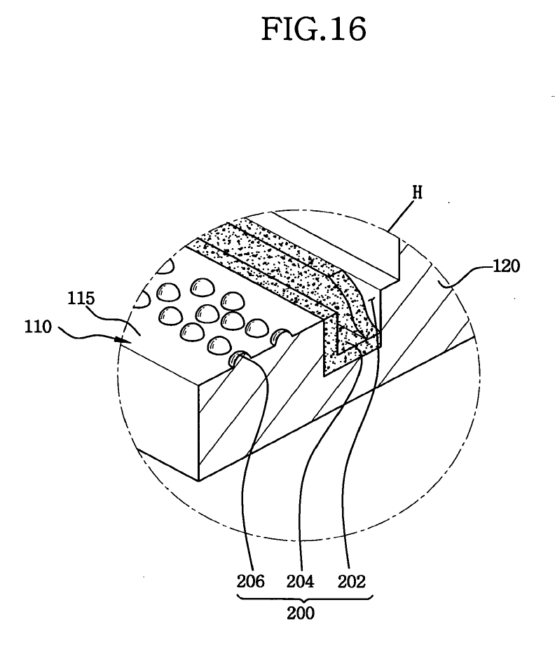

FIG. 15 is a partially cut out perspective view showing a supporting unit for an LCD panel according to another exemplary embodiment. FIG. 16 is an enlarged view showing a portion ‘H’ shown in FIG. 15.

The supporting unit for the LCD panel in FIGS. 15 and 16 is same as in FIGS. 1 and 2 except an impurity barrier. Thus, the same reference numerals will be used to refer to the same or like parts as those described in FIGS. 1 and 2 and any further explanation will be omitted.

Referring to FIGS. 15 and 16, an impurity barrier 200 is formed on a first surface 115 of a first support frame 110. The impurity barrier 200 includes a groove 202, a double-sided tape 204 disposed in the groove 202 and a plurality of protrusions 206 disposed on the first surface 115.

The groove 202 disposed between the protrusions 206 and a second support frame 120 has a band shape. A portion of impurities, which are externally provided to a space between a bottom surface of an LCD panel and the first supporting frame 110, are captured in the impurity barrier 200 by a gravitational force. The first double-sided tape 204 is disposed in the groove 202 so that the captured impurities are attached on the double-sided tape 204. Therefore, the captured impurities may not be separated from the groove 202 although an LCD apparatus is impacted by an external force.

The protrusions 206 disposed on the first surface 115 of the first support frame 110 are arranged in a band shape to increase a path length of remaining impurities, thereby preventing an inflow of the remaining impurities into the space.

According to the exemplary embodiment, the impurity barrier 200 includes the groove 202, the double-sided tape 204 disposed in the groove 202 and the protrusions 206 disposed on the first surface 115 so that the impurities may not pass through the impurity barrier 200.

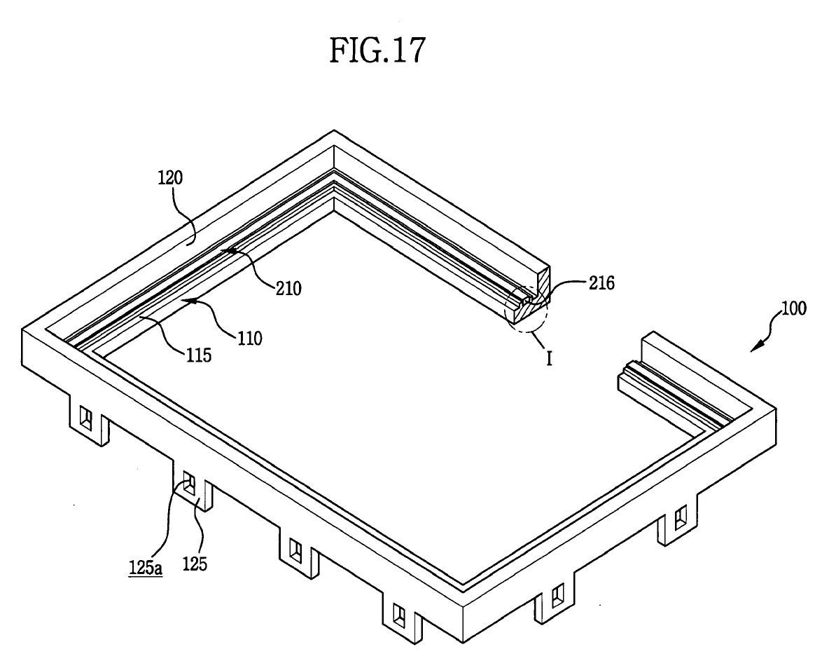

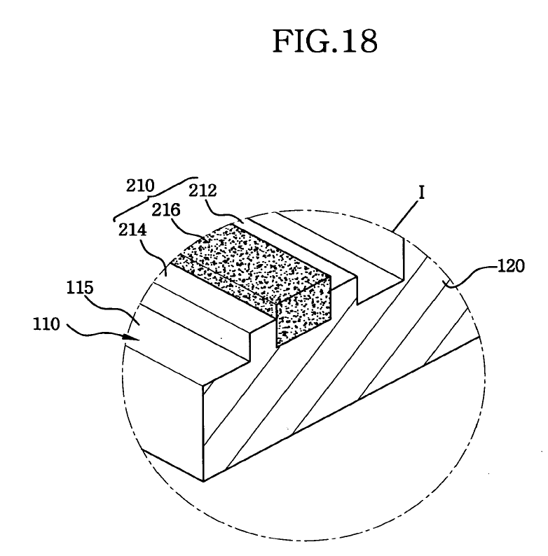

FIG. 17 is a partially cut out perspective view showing a supporting unit for an LCD panel according to another exemplary embodiment. FIG. 18 is an enlarged view showing a portion ‘I’ shown in FIG. 17.

The supporting unit for the LCD panel in FIGS. 17 and 18 is same as in FIGS. 1 and 2 except an impurity barrier. Thus, the same reference numerals will be used to refer to the same or like parts as those described in FIGS. 1 and 2 and any further explanation will be omitted.

Referring to FIGS. 17 and 18, an impurity barrier 210 is formed on a first surface 115 of a first support frame 110. The impurity barrier 210 includes a first wall 212, a second wall 214 and a buffer 216.

The first and second walls 212 and 214 have closed loop shapes that surround an opening formed at a central portion of the supporting unit 100. The first wall 212 is disposed between the second wall 214 and a second support frame 120.

The buffer 216 is disposed between the first and second walls 212 and 214, and has a rectangular cross-section. The buffer 216 includes an elastic material such as a rubber, a silicon compound, etc. The buffer 216 may also include a chemical filter having activated carbon, cotton, microfiber, etc.

The height of the buffer 216 may be adjusted so that a bottom surface of an LCD panel may not make contact with the upper surfaces of the first and second walls 212 and 214. The buffer 216 may be disposed between the first and second walls 212 and 214 through an automated manufacturing system. The buffer 216 absorbs an externally provided impact so as to protect the LCD panel, and the first surface 115 of the first support frame 110 is spaced apart from the bottom surface of the LCD panel by the buffer 216.

According to the exemplary embodiment, the impurity barrier 210 includes the first wall 212, the second wall 214 and the buffer 216 so that the impurities may not pass through the impurity barrier 210, and the LCD panel may be protected from the externally provided impact.

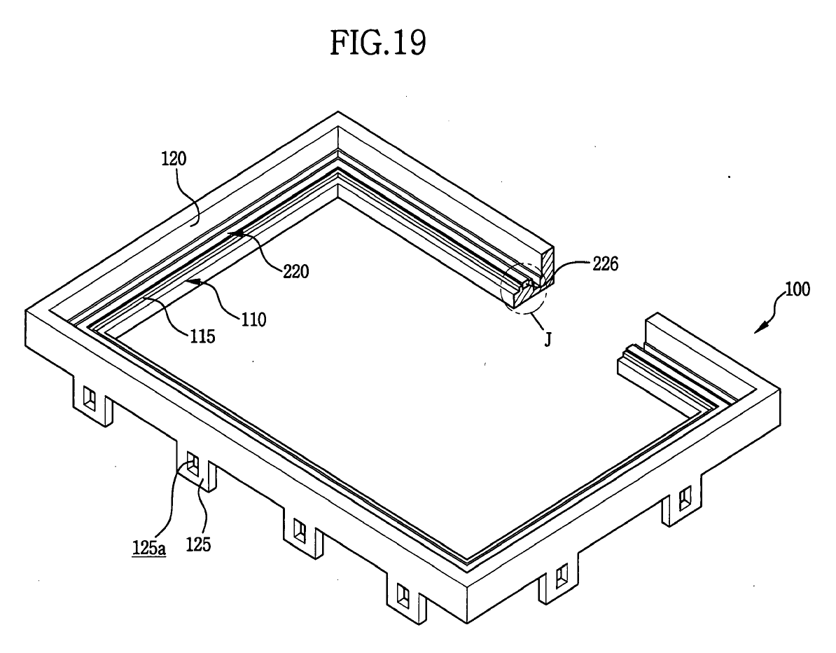

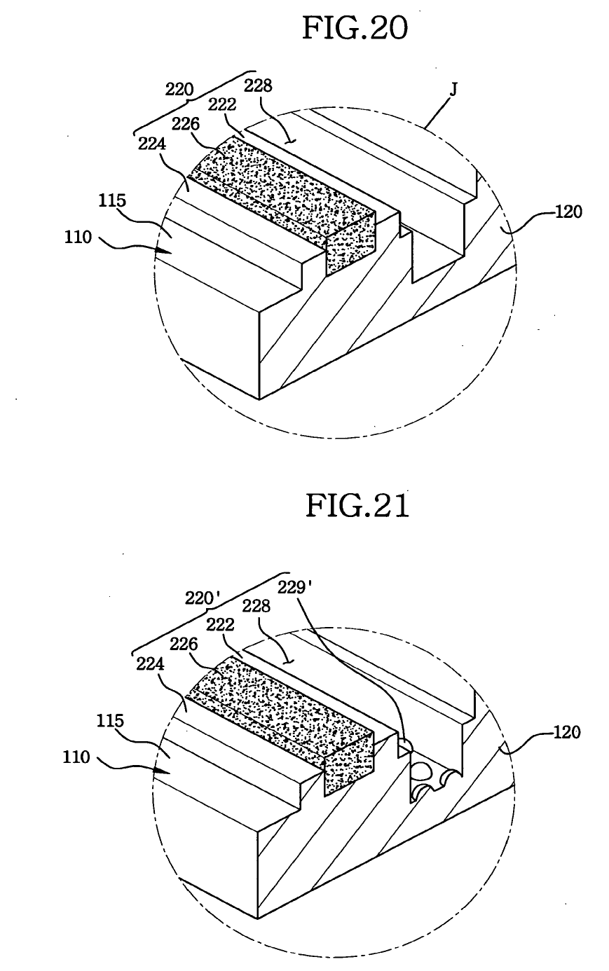

FIG. 19 is a partially cut out perspective view showing a supporting unit for an LCD panel according to another exemplary embodiment. FIG. 20 is an enlarged view showing a portion ‘J’ shown in FIG. 19.

The supporting unit for the LCD panel of FIGS. 19 and 20 is same as in FIGS. 1 and 2 except an impurity barrier. Thus, the same reference numerals will be used to refer to the same or like parts as those described in FIGS. 1 and 2 and any further explanation will be omitted.

Referring to FIGS. 19 and 20, an impurity barrier 220 is formed on a first surface 115 of a first support frame 110. The impurity barrier 220 includes a first wall 222, a second wall 224, a buffer 226 and a groove 228.

The groove 228 is formed between the first wall 222 and a second support frame 120 so that a portion of impurities, which are externally provided to a space between a bottom surface of the LCD panel and the first supporting frame 110, are captured in the groove 228 by a gravitational force.

The first and second walls 222 and 224 have closed loop shapes that surround an opening formed at a central portion of the supporting unit 100. The first wall 222 is disposed between the second wall 224 and a second support frame 120.

The buffer 226 disposed between the first and second walls 222 and 224 has a rectangular cross-section. The buffer 226 includes an elastic material such as a rubber, a silicon compound etc. The buffer 226 may also include a chemical filter having activated carbon, cotton, microfiber, etc.

The height of the buffer 226 may be adjusted so that a bottom surface of an LCD panel may not make contact with the upper surfaces of the first and second walls 222 and 224. The buffer 226 may be disposed between the first and second walls 222 and 224 through an automated manufacturing system. The buffer 226 absorbs an externally provided impact so as to protect the LCD panel, and the first surface 115 of the first support frame 110 is spaced apart from the bottom surface of the LCD panel by the buffer 226. In addition, remaining impurities may not pass through the buffer 226.

According to the exemplary embodiment, the impurity barrier 220 includes the first wall 222, the second wall 224, the buffer 226 and the groove 228 so that the impurities may not pass through the impurity barrier 220, and the LCD panel may be protected from the externally provided impact.

FIG. 21 is an enlarged partially cut out perspective view showing a supporting unit for an LCD panel according to another exemplary embodiment.

The supporting unit for the LCD panel in FIG. 21 is same as in FIGS. 19 and 20 except protrusions disposed in a groove. Thus, the same reference numerals will be used to refer to the same or like parts as those described in FIGS. 19 and 20 and any further explanation will be omitted.

Referring to FIG. 21, a plurality of protrusions 229′ is disposed in a groove 228 so that impurities captured in the groove 228 are disposed between the protrusions 229′.

According to the exemplary embodiment, an impurity barrier 220′ further includes the protrusions 229′ disposed in the groove 228 so that the captured impurities may not be separated from the groove 228 although an LCD apparatus is impacted by an external force.

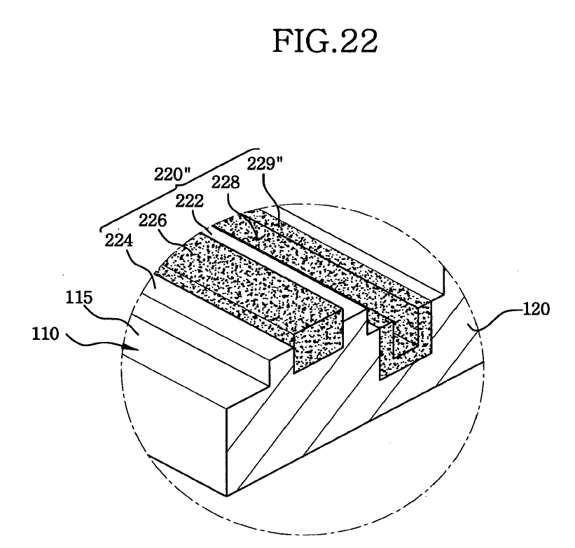

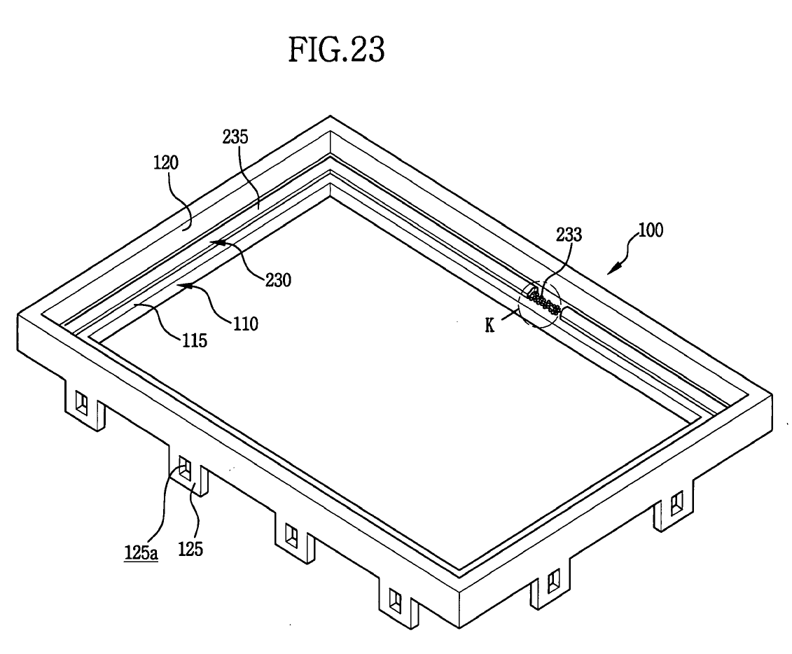

FIG. 22 is an enlarged partially cut out perspective view showing a supporting unit for an LCD panel according to another exemplary embodiment.

The supporting unit for the LCD panel in FIG. 22 is same as in FIGS. 19 and 20 except a double-sided tape disposed in a groove. Thus, the same reference numerals will be used to refer to the same or like parts as those described in FIGS. 19 and 20 and any further explanation will be omitted.

Referring to FIG. 22, a double-sided tape 229″ is disposed in a groove 228 so that impurities captured in the groove 228 are attached on the double-sided tape 229″.

According to the exemplary embodiment, an impurity barrier 220″ further includes the double-sided tape 229″ disposed in the groove 228 so that the attached impurities may not be separated from the groove 228 although an LCD apparatus is impacted by an external force.

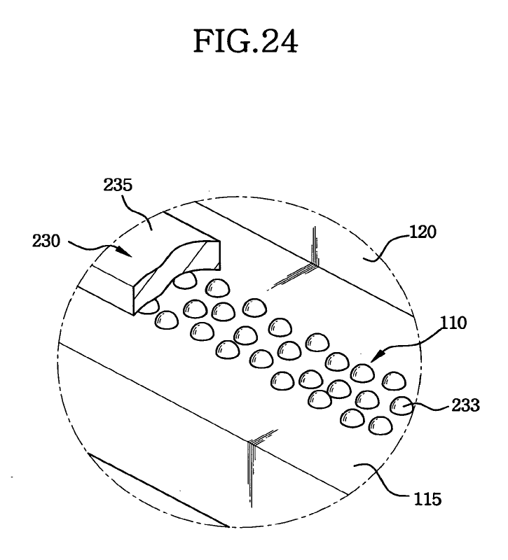

FIG. 23 is a partially cut out perspective view showing a supporting unit for an LCD panel according to another exemplary embodiment. FIG. 24 is an enlarged view showing a portion ‘K’ shown in FIG. 23.

The supporting unit for the LCD panel in FIGS. 23 and 24 is same as in FIGS. 1 and 2 except an impurity barrier. Thus, the same reference numerals will be used to refer to the same or like parts as those described in FIGS. 1 and 2 and any further explanation will be omitted.

Referring to FIGS. 23 and 24, an impurity barrier 230 is formed on a first surface 115 of a first support frame 110. The impurity barrier 230 includes a buffer 235 and a plurality of protrusions 233.

The protrusions 233 disposed on the first surface 115 surround an opening formed at a central portion of the supporting unit 100. The protrusions 233 increase the friction between the first surface 115 and the buffer 235 disposed on the protrusions 233 to prevent the drifting of the buffer 235. In addition, the protrusions 233 also increase a path length of impurities that are externally provided into a space between a bottom surface of an LCD panel and the first surface 115 so that the impurities may not pass through the impurity barrier 230.

The buffer 235 disposed on the protrusions 233 has a rectangular cross-section. The buffer 235 includes an elastic material such as a rubber, a silicon compound etc. The buffer 235 may also include a chemical filter having activated carbon, cotton, microfiber, etc.

Alternatively, a groove (not shown) may be formed between the protrusions 233 and a second support frame 120. In addition, a double-sided tape or a plurality of auxiliary protrusions may be disposed in the groove (not shown).

According to the exemplary embodiment, the impurity barrier 230 includes the protrusions 233 and the buffer 235 disposed on the protrusions 233 to prevent an inflow of the impurities into a space between the bottom surface of the LCD panel and the first surface 115.

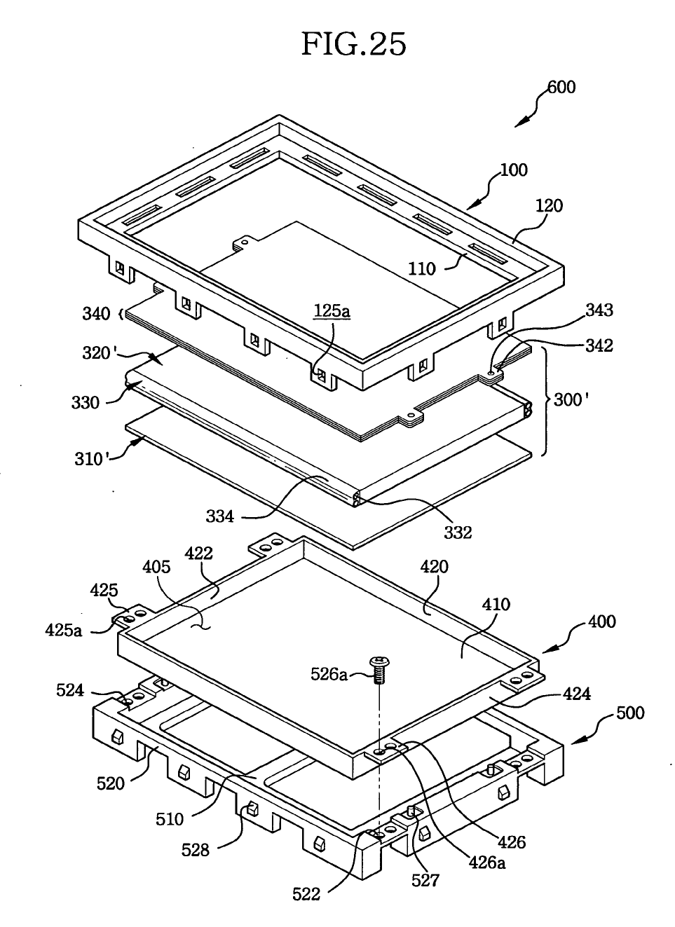

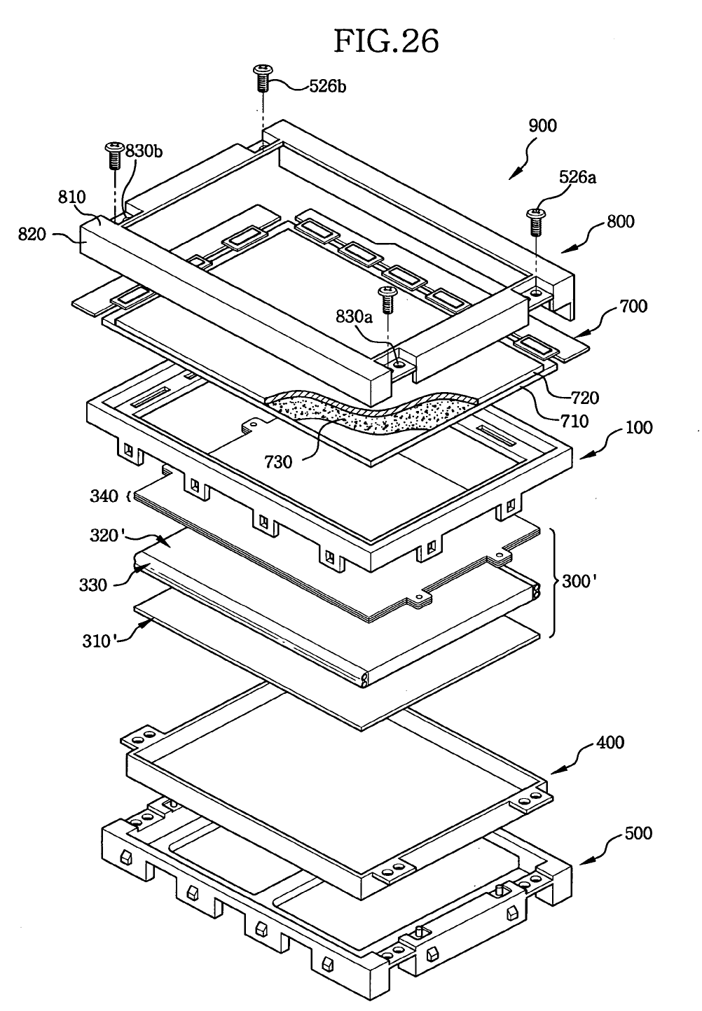

FIG. 25 is an exploded perspective view showing a backlight assembly according to an exemplary embodiment.

Referring to FIG. 25, the backlight assembly 600 includes a supporting unit 100 for an LCD panel, a lamp unit 300′, a first receiving container 400 and a second receiving container 500.

The first receiving container 400 includes a first bottom surface 410 and a plurality of first sidewalls 420. The first receiving container 400 may include a metal, a plastic, etc.

The first bottom surface 410 has a rectangular shape. The sidewalls 420 are disposed on sides of the first bottom surface 410 to form a receiving space 405. The sidewalls 420 include a first side face 422 and a second side face 424 corresponding to the first side face 422. A first bracket 425 and a second bracket 426 are protruded from the first and second side faces 422 and 424, respectively. A plurality of the first brackets and a plurality of the second brackets may be protruded from the first and second side faces 422 and 424, respectively. In this exemplary embodiment, two first brackets 425 and two second brackets 426 are protruded from the first and second side faces 422 and 424, respectively. Each of the first brackets 425 includes two first screw holes 425a, and each of the second brackets 426 includes two second screw holes 426a.

The lamp unit 300′ is disposed in the receiving space 405 of the first receiving container 400. The lamp unit 300′ includes a reflecting plate 310′, a light guide plate 320′, a lamp assembly 330 and optical sheets 340.

The reflecting plate 310′ is disposed on the first bottom surface 410 of the first receiving container 400. The reflecting plate 310′ includes a material having high reflectivity. The light guide plate 320′ disposed on the reflecting plate 310′ has a rectangular shape or a wedge shape.

The lamp assembly 330 disposed on a side surface of the light guide plate 320′ includes a lamp 332 and a lamp cover 334.

The lamp 332 is disposed at a position facing the side surface of the light guide plate 320′. The lamp includes a cold cathode fluorescent lamp (CCFL). The lamp cover 334 covers the lamp 332 to secure the lamp 332 to the side surface of the light guide plate 320′.

The optical sheets 340 are disposed on the light guide plate 320′. The optical sheets 340 uniformize luminance of a light exited from the light guide plate 320′. The optical sheets 340 include a diffusion sheet, a prism sheet, etc. A fixing portion 342 is protruded from the optical sheets 340. The fixing portion 342 includes a fixing hole 343. The optical sheets 340 may include a plurality of the fixing portions 342. In this exemplary embodiment, the optical sheets 340 include two fixing portions 342.

The supporting unit 100 is combined with the first receiving container 400. The supporting unit 100 prevents the separation of the lamp unit 300′ from the first receiving container 400, and receives the LCD panel.

The supporting unit 100 includes a first support frame 110, a second support frame 120 and an impurity barrier.

The second receiving container 500 receives the first receiving container 400. The second receiving container 500 has a rectangular parallelepiped shape, and an upper surface of the second receiving container 500 is opened. The second receiving container 500 includes a second bottom surface 510 and a plurality of second sidewalls 520. Third screw holes 522 are formed at an upper surface of one of the second sidewalls 520, and the third screw holes 522 are disposed at a position corresponding to the second screw holes 426a of the second brackets 426 of the first receiving container 400, respectively. Fourth screw holes 524 are formed at an upper surface of one of the second sidewalls 520, and the fourth screw holes 524 are disposed at a position corresponding to the first screw holes 425a of the first brackets 425 of the first receiving container 400, respectively. First screws 526 are secured with the first and fourth screw holes 425a and 524, and second screws (not shown) are secured with the second and third screw holes 426a and 522, respectively.

A securing pin 527 is disposed on the upper surface of the second sidewalls 520 of the second receiving container 500 to be secured with the fixing hole 343 formed in the fixing portion 342 of the optical sheets 340. A plurality of the securing pins may be disposed on the upper surface of the second sidewalls 520 of the second receiving container 500.

A plurality of securing projections 528 is formed on outer surfaces of the second sidewalls 520 of the second receiving container 500. The securing projections 528 are hooked on a securing hole 125a of the supporting unit 100.

FIG. 26 is an exploded perspective view showing an LCD apparatus according to an exemplary embodiment.

The backlight assembly in FIG. 26 is same as in FIG. 25. Thus, the same reference numerals will be used to refer to the same or like parts as those described in FIG. 25 and any further explanation will be omitted.

Referring to FIG. 25, the LCD apparatus 900 includes an LCD panel 700, a supporting unit 100 for an LCD panel 700, a lamp unit 300′, a first receiving container 400, a second receiving container 500 and a chassis 800.

The LCD panel 700 is disposed on a first support frame 110 of the supporting unit 100. A second support frame 120 prevents the drifting of the LCD panel 700.

The LCD panel 700 includes a thin film transistor (TFT) substrate 710, a color filter substrate 720 and a liquid crystal layer 730. The TFT substrate 710 is combined with the color filter substrate 720, and disposed at a position corresponding to the color filter substrate 720. The liquid crystal layer 730 is interposed between the TFT substrate 710 and the color filter substrate 720.

The chassis 800 prevents the separation of the LCD panel 700, and protects the LCD panel 700 from an impact that is externally provided to the LCD panel 700.

The chassis 800 includes a top chassis wall 810 and a plurality of side chassis walls 820.

A central portion of the top chassis wall 810 is opened so that a central portion of the color filter 720 of the LCD panel 700 is exposed. The top chassis wall 810 has a rectangular shape.

The side chassis walls 820 are disposed on sides of the top chassis wall 810 to surround the LCD panel 700.

A first auxiliary securing hole 830a and a second auxiliary securing hole 830b are formed at the top chassis wall 810. Alternatively, a plurality of the first auxiliary securing holes and a plurality of the second auxiliary securing holes may also be formed at the top chassis wall 810. In this exemplary embodiment, four first auxiliary securing holes 830a and four second auxiliary securing holes 830b are formed at the top chassis wall 810. The first and second auxiliary securing holes 830a and 830b are disposed at a position corresponding to the third and fourth screw holes 522 and 524, respectively. The third securing holes 522 and the first auxiliary securing holes 830a are combined with first securing screws 526a. The fourth securing holes 524 and the second auxiliary securing holes 830b are combined with second securing screws 526b.

According to the present invention, the supporting unit for the LCD panel includes the impurity barrier to prevent the inflow of the impurities that is externally provided into the space between the supporting unit and the LCD panel, thereby improving image display quality.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1.-5. (canceled)

6. A supporting unit for a liquid crystal display apparatus, the supporting unit comprising,
a first support frame including a surface that overlaps with a bottom surface of a liquid crystal display panel, and an opening through which a light is supplied to the liquid crystal display panel;
a second support frame protruded from sides of the first support frame and surrounding sides of the liquid crystal display panel; and
an impurity barrier including a first protrusion and formed at the surface of the first support frame, the first protrusion being integrally formed with the first support frame.

7. The supporting unit of claim 6, wherein the first protrusion is arranged in a band shape that surrounds the opening of the first support frame.

8. The supporting unit of claim 6, wherein the impurity barrier further comprises a groove disposed between the first protrusion and the second support frame.

9. The supporting unit of claim 8, wherein the impurity barrier further comprises a second protrusion disposed in the groove.

10. The supporting unit of claim 8, wherein the impurity barrier further comprises a double-sided tape disposed in the groove.

11.-29. (canceled)
